(19) United States
(12) Patent Application Publication
(10) Pub. No.: US 2013/0056344 A1
(43) Pub. Date: Mar. 7, 2013

(54) ELECTRIC CIRCUIT BREAKER WITH PYROTECHNIC ACTUATION

(71) Applicant: Evrard Borg, Sanary Sur Mer (FR)

(72) Inventor: Evrard Borg, Sanary Sur Mer (FR)

(73) Assignee: HERAKLES, Le Haillan (FR)

(21) Appl. No.: 13/635,178

(22) PCT Filed: Mar. 11, 2011
(86) PCT No.: PCT/FR11/50494

§ 371 Date: Nov. 12, 2012

(30) Foreign Application Priority Data
Mar. 15, 2010 (FR) 1051816

(51) Int. Cl. H01H 35/26

(52) U.S. Cl. 200/81 R

(57) ABSTRACT

An electric switch constituting a circuit breaker in particular, wherein a conductive blade is broken by the tripping of a pyrotechnically actuated gas generator.

According to the invention, a pyrotechnically actuated gas generator (15) is arranged so as to emit gases resulting from the combustion of a charge, and the generator is associated with a variable configuration chamber (17) and a breakable conductive blade (19) constitutes a bottom partition of said chamber, the breaking of the blade under the influence of the gases bringing about the interruption of the electric circuit of which the blade is a part.

The invention relates to a pyrotechnically actuated electric switch serving for example as a circuit breaker and preferably using a gas microgenerator, known per se. The preferred field of application is that of electric vehicles requiring the incorporation of electric circuit breakers allowing the safety of the vehicle and its occupants to be ensured in the event of a malfunction of the electric battery and/or of the associated electric circuit, for example in the event of an accident. The invention therefore aims primarily to protect the occupants of an electric automobile by providing for emergency shutdown of the driveline members. Such a device, however, can also be used in another field, such as aeronautics, space flight, marine or other.

The development of electric vehicles leads to the use of electric batteries of high storage capacity and high power, for example lithium-based batteries. The safe use of such an electric battery is therefore a major concern. But the safety of an electric vehicle does not depend only on the electric battery. The safety of all the links in the driveline and their connection to the battery must all be optimized, as they must resist the impacts and vibrations inherent in a road vehicle and consequently be rapidly isolated in the event of a short-circuit, resulting from an accident or a failure of the component itself.

The principal power elements to be electrically protected are therefore, firstly, the elements of the electric battery, then the drive train, the kinetic energy recovery device (supercapacitors), the electronics for converting direct current to alternating current, the system for controlling the electric power supplied to the motor, etc.

It is therefore essential to provide on such vehicles circuit breakers having rapid and reliable actuation, enabling emergency shutdown of malfunctioning components. This emergency shutdown can also be activated in the event of an operating anomaly or in the event of a major accident when one or more detectors have issued an alarm signal or a high risk to the occupants exists (electrocution, poisoning, burns . . . ).

Several devices and circuit breakers have been proposed. Known for example from document EP 1 502 683 is a pyrotechnically actuated circuit breaker equipped with a hollow piston, with a gas generator facing the piston and an electric conductor to be cut. The hollow piston within which the combustion gases accumulate under pressure upon pyrotechnic tripping moves and pushes on another element equipped with a sort of knife that cuts the conductor. This device is complex because it requires a large number of precision components that are relatively costly to produce. Moreover, the assembly of these components involves mastery of assembly and jointing operations with small mechanical tolerances, which makes it awkward to automate so as to achieve high production rates. In addition, this device can have a poor seal leading to gas leakage when pyrotechnic pressure is established, which can compromise the proper operation of the circuit breaker.

The invention allows all these difficulties to be overcome.

More particularly, the invention relates to a pyrotechnically actuated electric switch including, in one and the same housing, a pyrotechnically tripped gas generator and a variable configuration chamber associated with said gas generator, characterized in that it also comprises a conductive blade constituting, before said pyrotechnic tripping, a bottom partition of said chamber, in that two ends of said blade are accessible from the outside of the housing, in that said bottom partition comprises at least one breakable incision for electrically separating said accessible ends when the gases are emitted by said gas generator, in that a clearance space is defined on the other side of said gas generator with respect to said conductive blade, allowing an at least partially broken portion of said blade to enter it upon tripping of said gas generator.

In other words, in its most elementary version, the pyrotechnically actuated gas generator is directly facing the cutting blade which constitutes a partition of a chamber the volume of which is caused to vary upon tripping, driving toward the clearance space at least a portion of said bottom partition constituted by the blade. For example, the housing is obtained by plastic potting.

Advantageously, the clearance space defined on the other side of said gas generator is provided with walls having negative draft allowing rubbing of the broken portion of said blade along its entire travel within said clearance space.

The rubbing of the broken portion of the blade on the walls having negative draft of the clearance space enables said variable configuration chamber to be maintained gas-tight throughout the displacement of the broken portion of the blade. The combustion gases of said pyrotechnically tripped gas generator thus remain confined within said variable configuration chamber ensuring its pressurization.

The circuit breaker thus obtained has low mass and low bulk and is particularly well suited to automated series production. This automated production can in fact be organized very simply around an injection molding press, thus forming by plastic potting the outer housing containing the gas generator and the blade.

According to an advantageous embodiment, a mobile sealing element is interposed between the gas generator and the conductive blade.

For example, this mobile sealing element constitutes a sliding plug interposed within said variable configuration chamber between the gas generator and said breakable blade, before pyrotechnic tripping.

This element contributes to preventing the breaking of the blade from leading to gas leakage causing depressurization. Such depressurization could indeed induce the extinction of the pyrotechnic charge after the first moments of operation, or could cause the pressure applied to the blade to be insufficient, resulting in an incomplete breakage or a partial or too slow electric cutoff.

According to one variant, the movable sealing element is a closed bellows an opening whereof is connected to an outlet of said gas generator. In that case, the gas remains confined within the bellows after pyrotechnic tripping and causes the latter to expand, said expansion breaking said blade.

According to the variants defined above, residual combustion gases, which can be conductive, are also prevented from coming into contact with the broken ends of the blade. Better electric isolation is thus obtained.

The invention will be better understood and other advantages of it will appear more clearly in the light of the description that follows, of several pyrotechnically actuated electric switches conforming to its principle, given solely by way of example and made with reference to the appended non-limiting drawings wherein:

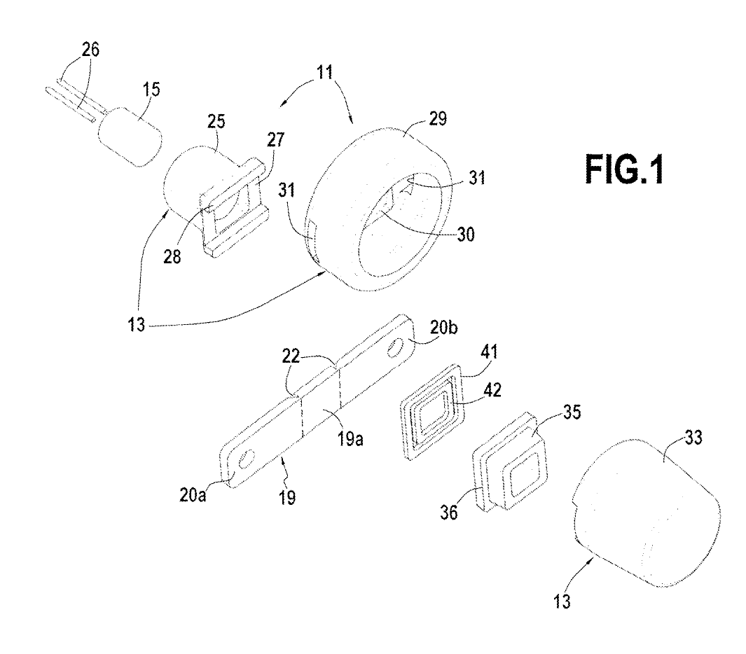

FIG. 1 is an exploded perspective view of a first embodiment of a device conforming to the invention;

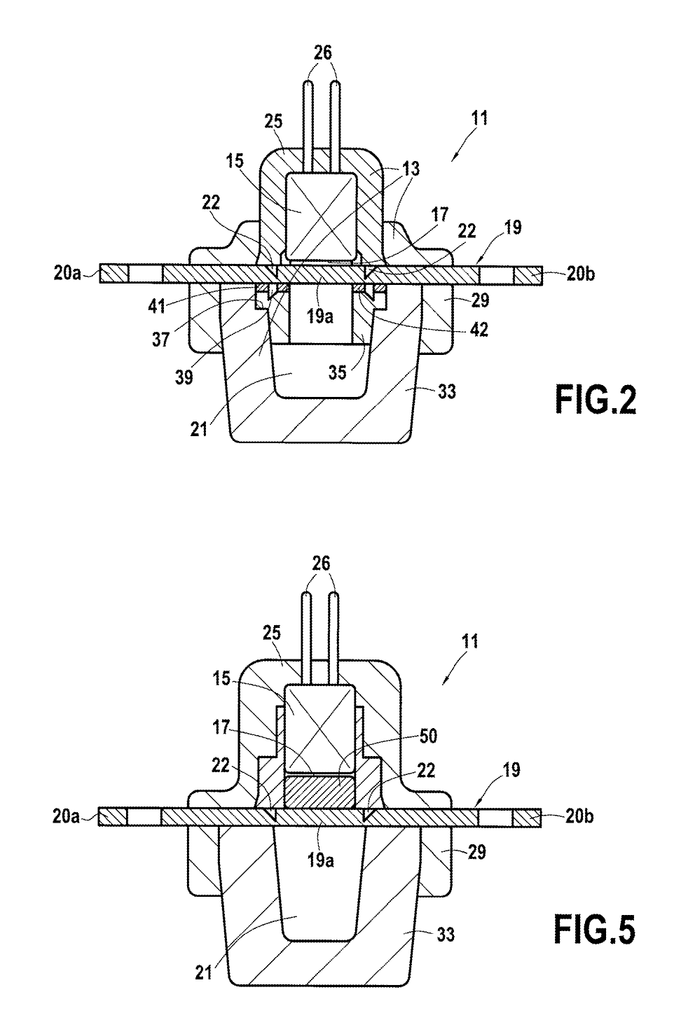

FIG. 2 is a section view of the same device, assembled;

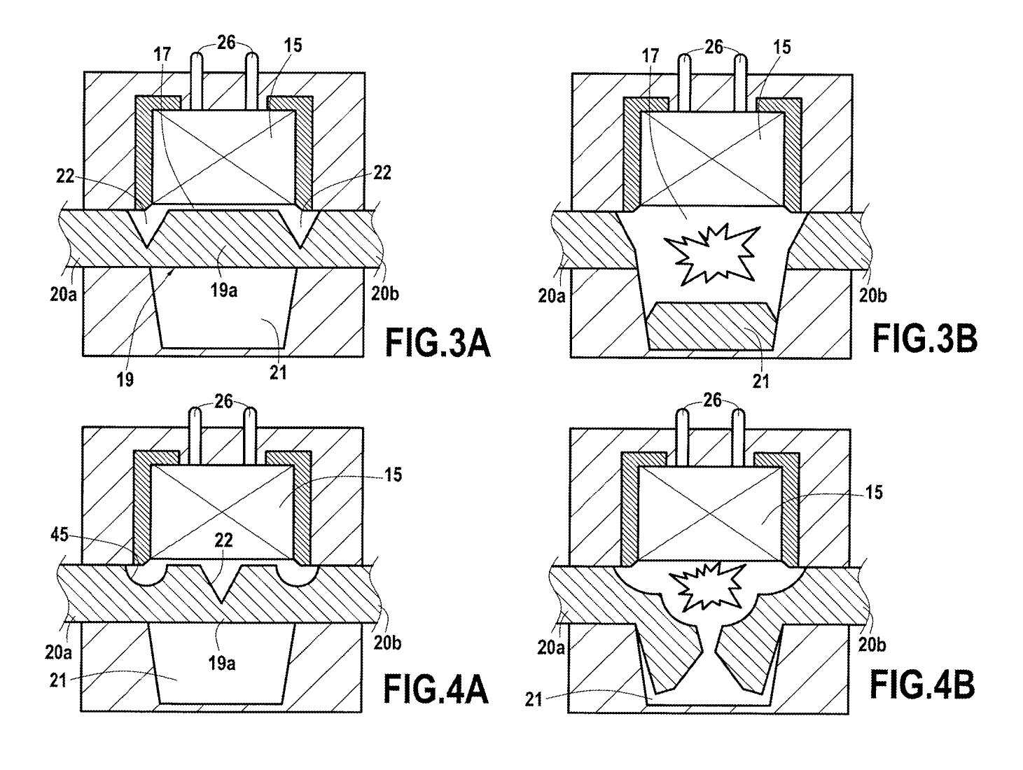

FIGS. 3A and 3B are simplified schematic views corresponding to the embodiment of FIGS. 1 and 2, to illustrate its operation;

FIGS. 4A and 4B are views analogous to FIGS. 3A, 3B illustrating a variant of the same embodiment;

FIG. 5 is a section view of a second embodiment of a device conforming to the invention;

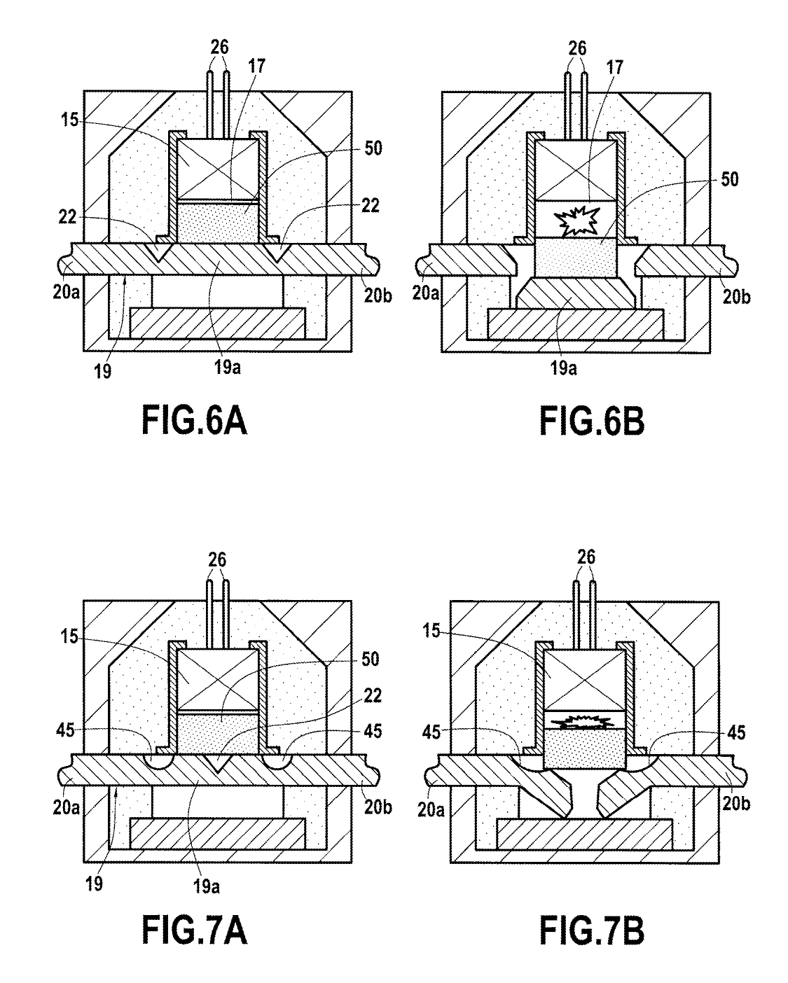

FIGS. 6A and 6B are simplified schematic views corresponding to the embodiment of FIG. 5, to illustrate its operation;

FIGS. 7A and 7B are views analogous to FIGS. 6A and 6B, illustrating a variant of the same embodiment;

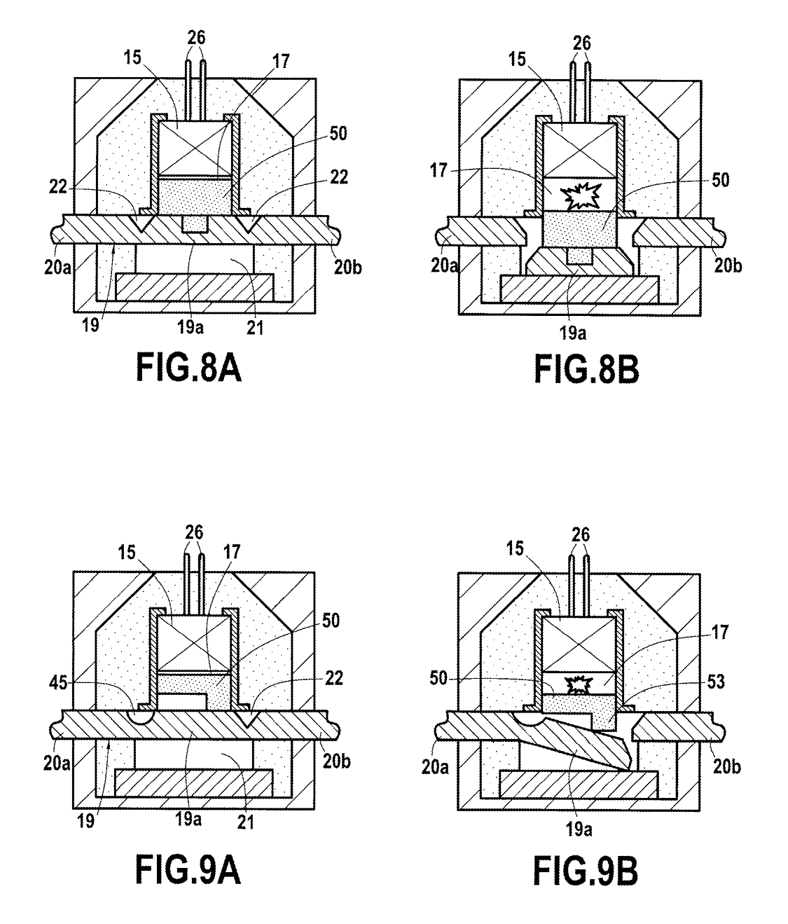

FIGS. 8A and 8B are views analogous to FIGS. 6A and 6B, illustrating a variant of the same embodiment;

FIGS. 9A and 9B are views analogous to FIGS. 6A and 6B, illustrating a variant of the same embodiment;

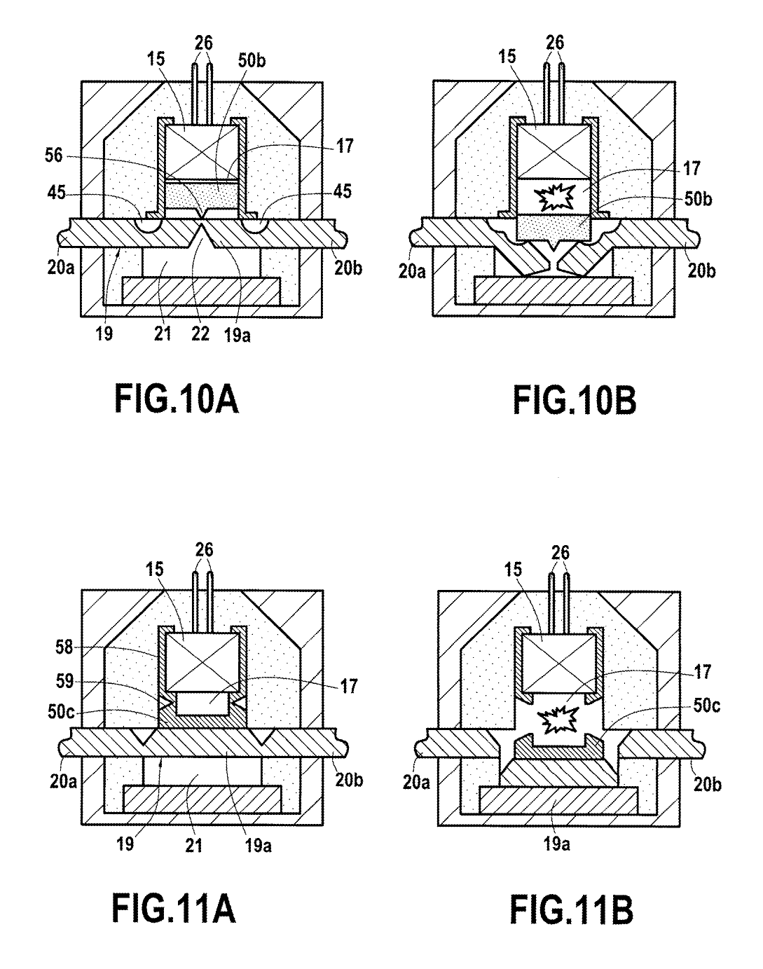

FIGS. 10A and 10B are views analogous to FIGS. 6A and 6B illustrating a variant of the same embodiment;

FIGS. 11A and 11B are views analogous to FIGS. 6A and 6B illustrating another embodiment;

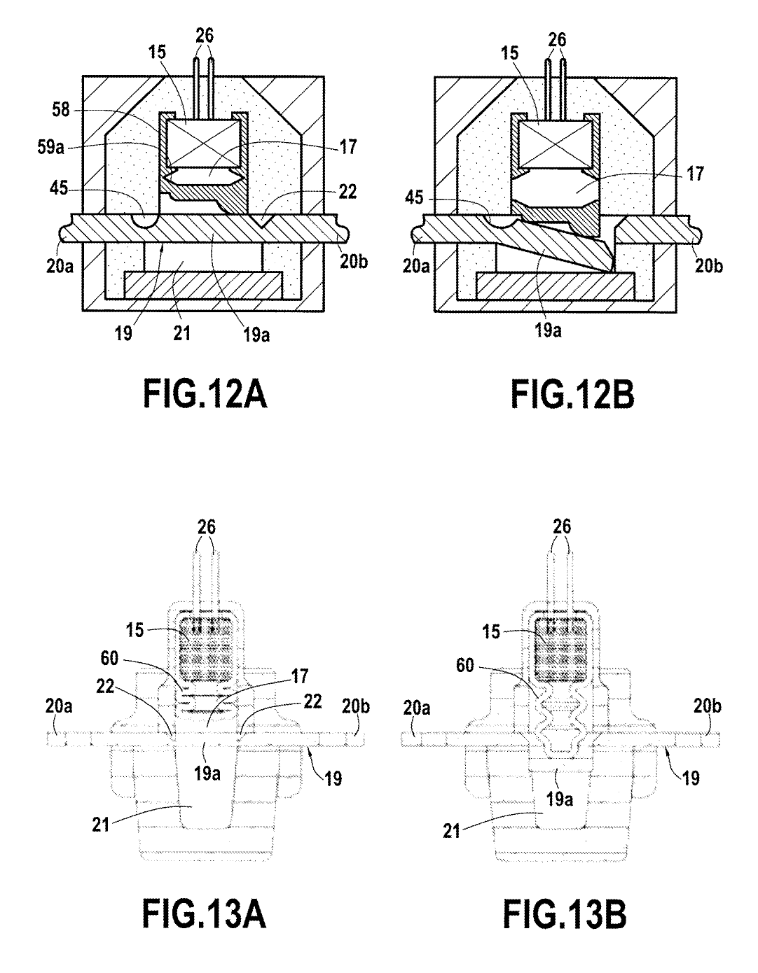

FIGS. 12A and 12B are views analogous to FIGS. 11A and 11B illustrating a variant; and

FIGS. 13A and 13B illustrate in section a third embodiment, before and after tripping, respectively.

Considering more particularly FIGS. 1, 2 and 3A, 3B, a pyrotechnically actuated electric switch 11 constituting a breaker is shown, having a housing 13 and a pyrotechnically actuated gas generator 15 installed in said housing wherein is defined a chamber 17 the configuration of which varies when gases are emitted by said gas generator. In the example, as will be seen further on, the volume of this chamber increases when the gases under pressure are emitted by the gas generator 15. A rectangular conductive blade 19, made of copper for example, runs through the housing 13. Its ends 20a, 20b extend outward from the housing and are therefore accessible to allow electric connection of the switch, that is its insertion into an electric circuit to be made safe.

According to an important feature of the invention, in the situation preceding the pyrotechnic tripping (that is before ignition of the gas generator and emission of the gas under pressure, here within the chamber 17), a partition 19a of the chamber 17 is constituted by the conductive blade and more particularly by the middle portion thereof. Moreover, this partition 19a which constitutes the bottom partition of the chamber 17, opposite the gas generator 15, comprises at least one breakable incision 22 (or any other precut arrangement), to electrically separate said accessible ends 20a, 20b of the blade when the gases are emitted by the gas generator, that is to say when the volume of the chamber 17 changes abruptly.

In addition, a clearance space 21 is defined on the other side of the gas generator from the conductive blade 19 constituting the bottom partition of the chamber 17 before tripping. An at least partially broken portion of the blade, that is said bottom partition 19a, can thus enter into the clearance space upon tripping of the gas generator 15. For example, such a breakable incision 22 is shaped so as to allow a portion of said blade (in this case the bottom partition 19a of the chamber 17) to be completely detached and driven into said clearance space 21 under the influence of said gases.

Advantageously, two parallel transverse incisions 22 are made in the blade in the vicinity of the boundaries of the chamber 17. The two other sides of the blade (in the longitudinal direction thereof) are located in the vicinity of the two edges of the opening of the clearance space 21.

In FIGS. 1 and 2 which illustrate an easily automated industrial implementation, it can be seen that the gas generator 15 is contained within a generally cylindrical closed receptacle 25, with two electric prongs 26 entering it for igniting the charge. This receptacle is aligned with a rectangular (or square) base 27 defining a rectangular opening bordered by two parallel ribs 28 between which is inserted the blade 19. The receptacle 25 is inserted into a sleeve 29 having a rectangular opening 30 and two slits 31 allowing passage of the blade. A closed pocket 33, assembled to the sleeve 29, defines said clearance space.

The receptacle 25, the sleeve 29 and the pocket 33 can be made of plastic and assembled as shown by welding or by any other method. They then define the housing 13.

In addition, to improve the reliability of the device, an open pocket 35 having a rectangular cross-section is inserted into the closed pocket 33. It comprises a rectangular parapet 36 resting on a shoulder 37 of the closed pocket 33. The parapet 36 comprises a rectangular incision 39 located facing the periphery of the bottom partition 19a defined in the blade. Thus, the central portion of the open pocket 35 is designed to separate from the upper portion of the parapet and to travel with the partition 19a into said clearance space 21. Two rectangular gaskets 41, 42 are interposed between the blade and the corresponding opening of the open pocket. These gaskets are located on either side of the rectangular incision 39.

The operation of the device is easily deduced from comparison of the simplified schematic sections of FIGS. 3A, 3B.

Upon pyrotechnic tripping, the pressurized gases accumulate in the chamber 17 and bring about the breakage of the two incisions 22 of the blade 19, driving the bottom partition 19a of the chamber 17, as a whole, toward the clearance space 21. The electric connection between the ends 20a, 20b of the blade is definitely interrupted. As the cross section of the clearance space 21 decreases from the opening toward the bottom of the pocket, the broken partition 19a embeds itself into the clearance space and remains jammed there, which prevents any intermittent contact between the two ends of the broken blade.

After breaking of the parapet 36 the gas-tightness on the side of the clearance space 21 preventing the gas from entering there is provided by the gasket 42, the bottom partition 19a and the inmost portion of the broken pocket 35 which rubs against the wall of the space 21.

In the variants and the embodiments which will now be described, analogous structural elements bear the same numerical labels.

For example, it is not necessary to completely detach the bottom partition of the chamber 17. The blade can comprise at least one fold area to allow at least a portion of the broken blade to fold and to enter the clearance space. This is what is illustrated by FIGS. 4A and 4B. According to this variant, a single breakable transverse incision 22 is provided in the middle of the bottom partition 19a. Two parallel thinned portions of the blade, located on either side of the incision near the edges of the chamber 17 and parallel to the incision define two fold areas 45. Thus, at the time of the pyrotechnic tripping, the bottom partition 19a breaks in the middle and the two portions of said partition fold and enter into the clearance space 21 while undergoing permanent deformation. The final situation is illustrated in FIG. 4B and electric continuity between the ends 20a, 20b is interrupted.

FIG. 5 illustrates another embodiment in a representation similar to that of FIG. 2. Shown again is an embodiment with a blade 19 having two parallel breakable incisions 22, in the vicinity of the two opposite edges of the opening of said clearance space. This embodiment is noteworthy in that a movable sealing element is incorporated between said gas generator and the conductive blade 19. It constitutes here a sliding plug 50 capable of moving within said variable configuration chamber. This sliding plug is interposed between the gas generator and the blade, before pyrotechnic tripping. Its gas-tight sliding prevents the gases from reaching the blade during and after tripping.

The operation of this embodiment appears clearly when comparing FIGS. 6A and 6B. Before tripping (FIG. 6A), the movable sealing element fills practically all the space between the gas generator and the blade. It bears on substantially the entire portion of the blade constituting the bottom partition 19a. After tripping (FIG. 6B), the gases emitted by the generator remain in the variable configuration chamber 17.

FIGS. 7A and 7B illustrate a variant of this embodiment according to which a single breakable incision 22 is defined in the middle of aid bottom partition 19a and two fold areas 45 are defined on either side thereof, as in the embodiment of FIGS. 4A and 4B. The operation is similar, the only difference being that the incision 22 is broken by the sliding plug 50 displaced under the influence of the increase in pressure in the chamber.

The variant of FIGS. 8A and 8B is similar to the embodiment of FIGS. 6A and 6B, the only difference being that the sliding plug 50 is attached to said bottom partition 19a defined by the two breakable incisions. The operation is identical to that of the embodiments of FIGS. 6A and 5B.

In the embodiment of FIGS. 9A and 9B, the sliding plug 50a exhibits a lateral extension 53 constituting a rib, which bears on a portion of said bottom partition 19a adjacent to a single breakable incision 22 located near a side edge of said partition. A fold area 45 is defined parallel to the breakable incision 22 in the vicinity of the other end of said end partition. At the time of the pyrotechnical tripping, the incision 22 breaks and the lateral extension of the sliding plug facilitates folding as shown in FIG. 9B.

According to the variant of FIGS. 10A and 10B, said bottom partition comprises a single breakable incision 22 in its middle and two fold areas 45 located on either side thereof near the ends of the opening of the clearance space 21. Further, the sliding plug 50b is provided with a projecting rib 56 bearing, prior to tripping, against the bottom partition 19a, parallel to said breakable incision. After tripping, the situation is that of FIG. 10B, the gases being confined within the chamber thanks to the sliding plug 50b.

The variant of FIGS. 11A and 11B is similar to that of FIGS. 6A and 6B with regard to the structure of the blade 19. On the other hand, the movable sealing element 50c is incorporated, before pyrotechnic tripping, with a pouch 58 of said gas generator 15 and this pouch has at the side a breakable area 59 enabling, upon pyrotechnic tripping, the separation of the lower portion of the pouch which then plays the same role as the sliding plug described above.

The variant of FIGS. 12A and 12B is similar to that of FIGS. 9A and 9B as regards the structure of the blade 19 and the shape of the movable sealing element but it is incorporated, before pyrotechnic tripping, with the pouch 58 of said gas generator 15 and exhibits a breakable area 59a allowing the sliding plug to detach under the influence of the pressure of the gases.

Finally, according to the embodiment of FIGS. 13A and 13B, said movable sealing element is a closed bellows 60 installed in the variable configuration chamber 17, one opening of which is connected to an outlet of said gas generator. Before tripping, the situation is illustrated in FIG. 13A, the bellows 60 being retracted into itself. The structure of the blade conforms to that of FIG. 5, for example. After tripping (FIG. 13B), the gases bring about an elongation of the bellows 60 within said variable configuration chamber 17, which brings about the breakage of said bottom partition 19a within the clearance space 21. In this embodiment, the combustion gases remain confined within the bellows 60.

It is clear that the invention is not limited to only the embodiments described above but also include in particular all possible combinations of the structural elements of the different variants, particularly the blade structure and that of the movable sealing element constituting either a sliding plug or a closed bellows.

1. A pyrotechnically actuated electric switch comprising, in one and the same housing, a pyrotechnically tripped gas generator and a variable configuration chamber associated with said gas generator, a conductive blade constituting, before said pyrotechnic tripping, a bottom partition of said chamber, wherein two ends of said blade are accessible from the outside of the housing, wherein said end partition comprises at least one breakable incision for electrically separating said accessible ends when the bases are emitted by said gas generator and wherein a clearance space is defined on the other side of said gas generator with respect to said conductive blade, allowing an at least partially broken portion of said blade to enter it upon tripping of said gas generator.

2. The switch according to claim 1, wherein a movable sealing element is interposed between said gas generator and the conductive blade.

3. The switch according to claim 2, wherein said movable sealing element constitutes a sliding plug interposed in said variable configuration chamber between the gas generator and said blade before pyrotechnic tripping.

4. The switch according to claim 2, wherein said movable sealing element is a closed bellows installed within said variable configuration chamber one opening of which is connected to an outlet of said gas generator.

5. The switch according to claim 3, wherein said at least one breakable incision is shaped so as to allow a portion of said blade to be completely detached and driven into said clearance space by said movable sealing element.

6. The switch according to claim 3, wherein said blade comprises at least one fold area to allow folding of at least a portion of said broken blade and its entry into said clearance space by said movable sealing element.

7. The switch according to claim 6, wherein it comprises two fold areas defined on either side of said breakable incision.

8. The switch according to claim 6, wherein it comprises a single fold area and a single breakable incision.

9. The switch according to claim 2, wherein said movable sealing element comprises a rib in the vicinity of said breakable incision.

10. The switch according to claim 2, wherein said movable sealing element is incorporated, before pyrotechnic tripping, with a pouch of said gas generator and in that said pouch comprises a breakable area.
